(19) United States
(12) Patent Application Publication
(10) Pub. No.: US 2023/0217421 A1
(43) Pub. Date: Jul. 6, 2023

(54) UPLINK GAP CONFIGURATION

(71) Applicant: QUALCOMM Incorporated, San Diego, CA (US)

(72) Inventors: Changhwan PARK, San Diego, CA (US); Timo Ville VINTOLA, San Diego, CA (US); Valentin Alexandru GHEORGHIU, Yokohama-shi (JP)

(21) Appl. No.: 18/052,891

(22) Filed: Nov. 4, 2022

Related U.S. Application Data
(60) Provisional application No. 63/266,512, filed on Jan. 6, 2022.

(51) Int. Cl. H04W 72/0446; H04L 5/00; H04L 5/14

(52) U.S. Cl. CPC H04W 72/0446; H04L 5/0092; H04L 5/14

(57) ABSTRACT

Aspects of the present disclosure relate to wireless communications, and more particularly, to techniques and devices for uplink gap configuration. Certain aspects are directed to an apparatus for wireless communications at a user equipment (UE). The UE may include a memory comprising instructions, and one or more processors configured to execute the instructions. In some examples, the instructions may cause the apparatus to obtain, from a base station, a first time division duplex (TDD) configuration for wireless communications between the UE and the base station. The instructions may cause the apparatus to obtain, from the base station, an uplink gap pattern (ULGP) configuration indicating a first ULGP associated with a first time window and the first TDD.

### CROSS REFERENCE TO RELATED APPLICATION(S)

This application claims the benefit of U.S. Provisional Application Ser. No. 63/266,512, entitled “UPLINK GAP CONFIGURATION” and filed on Jan. 6, 2022, the disclosure of which is expressly incorporated by reference herein in its entirety.

### BACKGROUND

### Technical Field

The present disclosure generally relates to communication systems, and more particularly, to devices and method for uplink gap configuration.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communications, comprising a memory comprising instructions and one or more processors configured to execute the instructions. In some examples, the one or more processors may cause the apparatus to obtain, from a base station, a first time division duplex (TDD) configuration for wireless communications between the apparatus and the base station. In some examples, the one or more processors may cause the apparatus to obtain, from the base station, an uplink gap pattern (ULGP) configuration indicating a first ULGP associated with a first time window and the first TDD configuration. In some examples, the one or more processors may cause the apparatus to output for transmission, to the base station, uplink signaling according to a distribution of the one or more uplink gaps within the first time window, wherein the distribution of the one or more uplink gaps is based on the first TDD configuration and the first ULGP configuration.

Certain aspects are directed to an apparatus for wireless communications, comprising a memory comprising instructions and one or more processors configured to execute the instructions. In some examples, the one or more processors may cause the apparatus to output, for transmission to a user equipment (UE), a first time division duplex (TDD) configuration for wireless communications between the UE and the apparatus. In some examples, the one or more processors may cause the apparatus to output, for transmission to the UE, an uplink gap pattern (ULGP) configuration indicating a first ULGP associated with a first time window and the first TDD configuration.

Certain aspects are directed to a method for wireless communications at a user equipment (UE). In some examples, the method may include obtaining, from a base station, a first time division duplex (TDD) configuration for wireless communications between the UE and the base station. In some examples, the method may include obtaining, from the base station, an uplink gap pattern (ULGP) configuration indicating a first ULGP associated with a first time window and the first TDD configuration. In some examples, the method may include outputting for transmission, to the base station, uplink signaling according to a distribution of the one or more uplink gaps within the first time window, wherein the distribution of the one or more uplink gaps is based on the first TDD configuration and the first ULGP configuration.

Certain aspects are directed to a method for wireless communications at a base station. In some examples, the method may include outputting for transmission, to a user equipment (UE), a first time division duplex (TDD) configuration for wireless communications between the UE and the base station. In some examples, the method may include outputting, for transmission to the UE, an uplink gap pattern (ULGP) configuration indicating a first ULGP associated with a first time window and the first TDD configuration.

Certain aspects are directed to an apparatus for wireless communications. In some examples, the apparatus may include means for obtaining, from a base station, a first time division duplex (TDD) configuration for wireless communications between the apparatus and the base station. In some examples, the apparatus may include means for obtaining, from the base station, an uplink gap pattern (ULGP) configuration indicating a first ULGP associated with a first time window and the first TDD configuration. In some examples, the apparatus may include means for outputting for transmission, to the base station, uplink signaling according to a distribution of the one or more uplink gaps within the first time window, wherein the distribution of the one or more uplink gaps is based on the first TDD configuration and the first ULGP configuration.

Certain aspects are directed to an apparatus for wireless communications. In some examples, the apparatus may include means for outputting for transmission, to a user equipment (UE), a first time division duplex (TDD) configuration for wireless communications between the UE and the apparatus. In some examples, the apparatus may include means for outputting, for transmission to the UE, an uplink gap pattern (ULGP) configuration indicating a first ULGP associated with a first time window and the first TDD configuration.

A non-transitory computer-readable medium having instructions stored thereon that, when executed by a user equipment (UE), cause the UE to perform operations. In some examples, the operations may include obtaining, from a base station, a first time division duplex (TDD) configuration for wireless communications between the UE and the base station. In some examples, the operations may include obtaining, from the base station, an uplink gap pattern (ULGP) configuration indicating a first ULGP associated with a first time window and the first TDD configuration. In some examples, the operations may include outputting for transmission, to the base station, uplink signaling according to a distribution of the one or more uplink gaps within the first time window, wherein the distribution of the one or more uplink gaps is based on the first TDD configuration and the first ULGP configuration.

A non-transitory computer-readable medium having instructions stored thereon that, when executed by a base station, cause the base station to perform operations. In some examples, the operations may include outputting for transmission, to a user equipment (UE), a first time division duplex (TDD) configuration for wireless communications between the UE and the base station. In some examples, the operations may include outputting, for transmission to the UE, an uplink gap pattern (ULGP) configuration indicating a first ULGP associated with a first time window and the first TDD configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a block diagram illustrating example uplink gap slots for each of the four corresponding to uplink gap patterns (UGLPs).

FIG. 5 is a block diagram illustrating example time-division duplex (TDD) slot structures and corresponding communication impacts caused by uplink gap slots.

FIG. 6 is a block diagram illustrating example uplink gap distributions in an example TDD slot configuration.

FIG. 7 is a block diagram illustrating example uplink gap distributions in an example TDD slot configuration.

FIG. 8 is a block diagram illustrating example uplink gap distributions in an example TDD slot configuration.

FIG. 9 is a block diagram illustrating example uplink gap distributions in example TDD slot configurations and SCS configurations.

FIG. 10 is a call-flow diagram illustrating example communications between a UE and a base station for an uplink gap process.

FIG. 11 is a flowchart of a method of wireless communication performed by a UE.

FIG. 12 is a diagram illustrating another example of a hardware implementation for another example apparatus.

FIG. 13 is a flowchart of a method of wireless communication performed by a BS.

FIG. 14 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A base station may provide a user equipment (UE) with information for configuring an uplink gap at the UE. For example, the base station may provide the UE with one or more uplink gap patterns (ULGPs), as well as an uplink gap length (UGL) and uplink gap repetition periodicity (UGRP) corresponding to each of the one or more ULGPs. For instance, the UGL may indicate a number of consecutive static uplink slots configured as an uplink gap, per UGRP. For example, if the UE is communicating using a 120 kHz subcarrier spacing (SCS) (e.g., wherein the duration of each slot is ⅛ milliseconds (ms)), the UGRP is 20 ms, and the UGL is 1 ms, then the UE may use eight consecutive static uplink slots every 20 ms to perform an uplink gap process.

During the uplink gap process, the UE may perform self-calibration and second monitoring processes, during which the UE may not transmit uplink signaling to the base station. In one example, during an uplink gap process, the UE may perform proximity detection to determine if there is a person nearby. Such proximity detection may provide the UE with information that controls a transmission power of the UE (e.g., a lower transmission power may be applied if a person is close to the UE, relative to a transmission power when a person is not close to the UE). In another example, the UE may transmit a low power signal (e.g., a signal that will not be received by the base station) that the UE will receive and use to perform self-calibration. Here, the UE may determine whether the power of the received signal a power that the UE expected. Based on this information, the UE may calibrate RF components and transmit/receive logic (e.g., power amplified (PA), transceiver, etc.). In yet another example, the UE may perform self-calibration based on UE temperature. In this example, an internal temperature of the UE may trigger the UE to perform recalibration of components or perform tests to confirm that the components are working correctly. Thus, if the UE has been transmitting for a long duration of time it may heat up, and the UE may want to make sure everything still works correctly at that temperature. It should be noted that the examples provided above are not limiting, and any suitable self-calibration and/or monitoring process may be performed by the UE during the uplink gap process.

During the uplink gap process, the UE is not expected to be scheduled with an uplink transmission by the base station. Thus, depending on the uplink/downlink slot configuration (e.g., time-division duplex (TDD) pattern), the scheduling delay (e.g., K1) between a downlink transmission and an uplink acknowledgment/negative-acknowledgement (ACK/NACK), the ULGP pattern, etc., downlink transmissions can also be blanked (e.g., no ACK/NACK provided in response to the downlink transmission due to uplink gap process) which results in loss of downlink throughput and downlink communication opportunities.

In some examples, the UE and the base station may use certain timers to control aspects of wireless communication between the devices. The timers may include timer-based bandwidth part (BWP) switching, discontinuous reception (DRX) timers, time alignment (TA) timers, etc. However, an uplink gap process may prevent the UE from providing the base station with uplink data in response to a timer expiring. As such, the uplink gap process may result in a failed connection or communication between the UE and the base station.

Thus, in certain aspects, the UE may uniformly distribute the use of an uplink gap process throughout a UGRP. For example, using a consecutive number of uplink slots will effectively blank a relatively long and continuous portion of the UGRP, potentially preventing the UE from responding to timers for a long period of time. Thus, by uniformly distributing use of an uplink gap process throughout a UGRP (e.g., assigning uplink gap process to every other uplink slot instead of every consecutive uplink slot), the UE may avoid long periods of blanked downlink slots. As such, the UE may have more opportunity to take action when a timer expires or before expiration of the timer.

In certain aspects, if the UE is configured with a TDD uplink/downlink pattern consisting of multiple contiguous uplink slots (e.g., an uplink slot that immediately follows another uplink slot), the UE may use the last uplink slot within the contiguous set of multiple uplink slots for the uplink gap process. As such, the UE may utilize the first uplink slot of the set of multiple uplink slots for ACK/NACK and other uplink communications, while reserving the last uplink slot for an uplink gap process. In some examples, the base station may provide the UE with an offset value configured to indicate which uplink slot of the multiple uplink slots to use for uplink gap processes.

In certain aspects, the UE may be configured to communicate with the base station using a TDD uplink/downlink slot pattern that consists of multiple radio resource control (RRC) configured slot patterns. For example, a first RRC slot pattern may include a different number of uplink slots relative to a second RRC slot pattern. More specifically, the first RRC slot pattern may include two or more contiguous uplink slots, whereas the second RRC slot pattern may only include one. In such an example, the UE may map the uplink gap process to the last uplink slot in time of the contiguous slots of the first RRC slot pattern. That is, the UE may perform an uplink gap process using an uplink slot in an RRC pattern that has more UL slots than the other RRC pattern.

If the UE is configured to communicate with the base station using a TDD uplink/downlink slot pattern that consists of multiple RRC configured slot patterns, and each of the slot patterns have the same number of UL slots, then the UE may uniformly distribute the uplink slots used for an uplink gap process within the UGRP. In this way, the uplink gap process does not rely on a contiguous group of uplink slots that may blank out a relatively long duration of downlink communications. Moreover, by spreading out the uplink slots used for uplink gap processes, the UE may be more capable of addressing timer expirations.

In certain aspects, the UE may be configured with multiple BWPs of which use different subcarrier spacing (SCS). For example, the UE may be configured with an active first BWP that uses a 120 kHz SCS, and a non-active second BWP that uses a 60 kHz SCS. In this example, if the UE changes from the first BWP to the second BWP, the UE may simply scale down the number of uplink slots used for uplink gap processes. Using the example above, the UE may be configured to use a maximum of eight uplink slots for an uplink gap process within one UGRP using the first BWP using the 120 kHz SCS. Accordingly, if the UE switches to the second BWP that uses the 60 kHz SCS, the UE may simply scale down the maximum number of eight slots to four slots for the same UGRP. The scaling down works here because the UGL is the same for both the first BWP and the second BWP, and because the UGL is greater than a slot length for both the 120 kHz and 60 kHz SCSs.

However, there may be cases when UGL is shorter than a slot length with respect to an SCS for an activated BWP. For example, if the first BWP is associated with a 0.125 ms UGL (e.g., a single uplink gap slot within the UGRP), the UE will not be able to switch to the second BWP. This is because the second BWP uses a 60 kHz SCS, and each slot of the 60 kHz SCS is greater than 0.125 ms. Thus, the UE would not be able to use a full uplink slot for the uplink gap, because the 0.125 ms would only provide for half of an uplink slot, which would render the entire slot unavailable. Thus, in such a case, the UE may scale up the UGL when the UGL is shorter than a slot length with respect to a particular SCS.

In some examples, if a UE is configured with multiple BWPs that are associated with different SCSs, then the UE may map the uplink gap process to uplink slots according to the lowest SCS. As such, if the UE switches from one BWP to another BWP in any direction, the timing of the uplink gap pattern will be the same time in either BWP. This provides the UE with the ability to schedule other sensors (e.g., proximity detection sensors, etc.) in a manner transparent to BWP switching. That is, the BWP may switch from one SCS to another SCS with no affect on the scheduling of the sensors or performance of any uplink gap processes. Similarly, if a UE is configured with different BWPs having different SCSs in a carrier aggregation scenario, then the uplink gap mapping may be determined by the UE based on the lowest SCS among all active cells having active BWPs.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

In certain aspects, the base station may query the UE to determine whether the UE can use an uplink gap configuration. For example, if the UE can improve its communication with the base station by performing uplink gap processes, then the UE may request an uplink gap configuration from the base station. In some examples, the UE may request the uplink gap configuration without a query from the base station.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

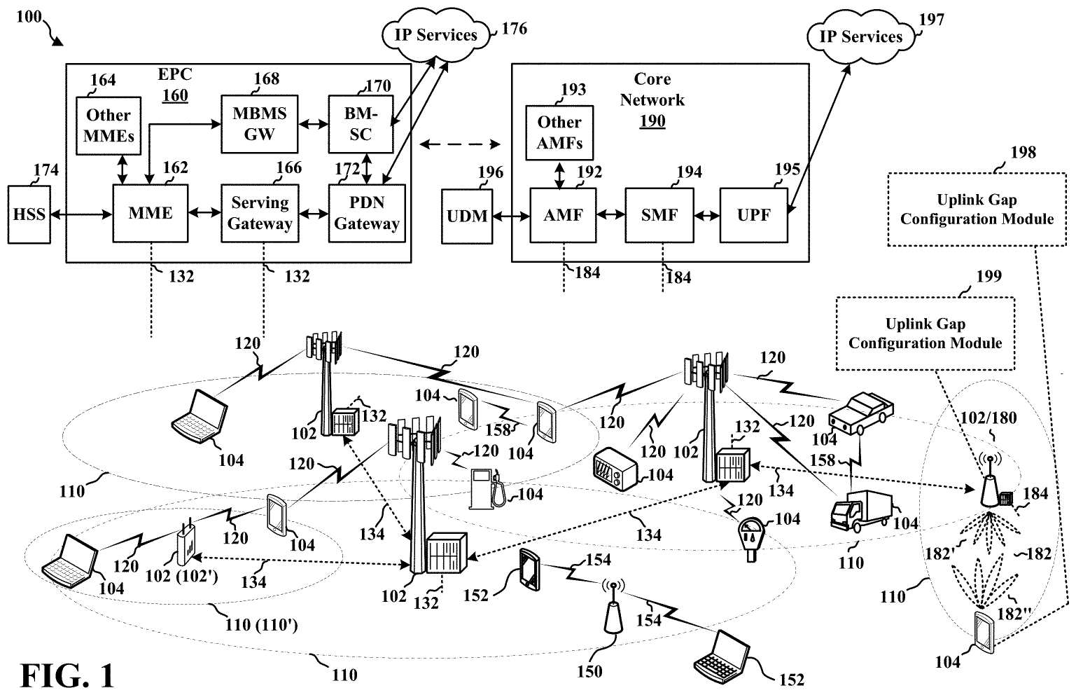

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNB s) (HeNB s), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include an uplink gap configuration module 198 configured to obtain, from a base station, a first time division duplex (TDD) configuration for wireless communications between the apparatus and the base station; obtain, from the base station, an uplink gap pattern (ULGP) configuration indicating a first ULGP associated with a first time window and the first TDD configuration; and output for transmission, to the base station, uplink signaling according to the a distribution of the one or more uplink gaps within the first time window, wherein the distribution of the one or more uplink gaps is based on the first TDD configuration and the first ULGP configuration.

In certain aspects, the base station 180 may include an uplink gap configuration module 199 configured to output, for transmission to a user equipment (UE), a first time division duplex (TDD) configuration for wireless communications between the UE and the apparatus; and output, for transmission to the UE, an uplink gap pattern (ULGP) configuration indicating a first ULGP associated with a first time window and the first TDD configuration.

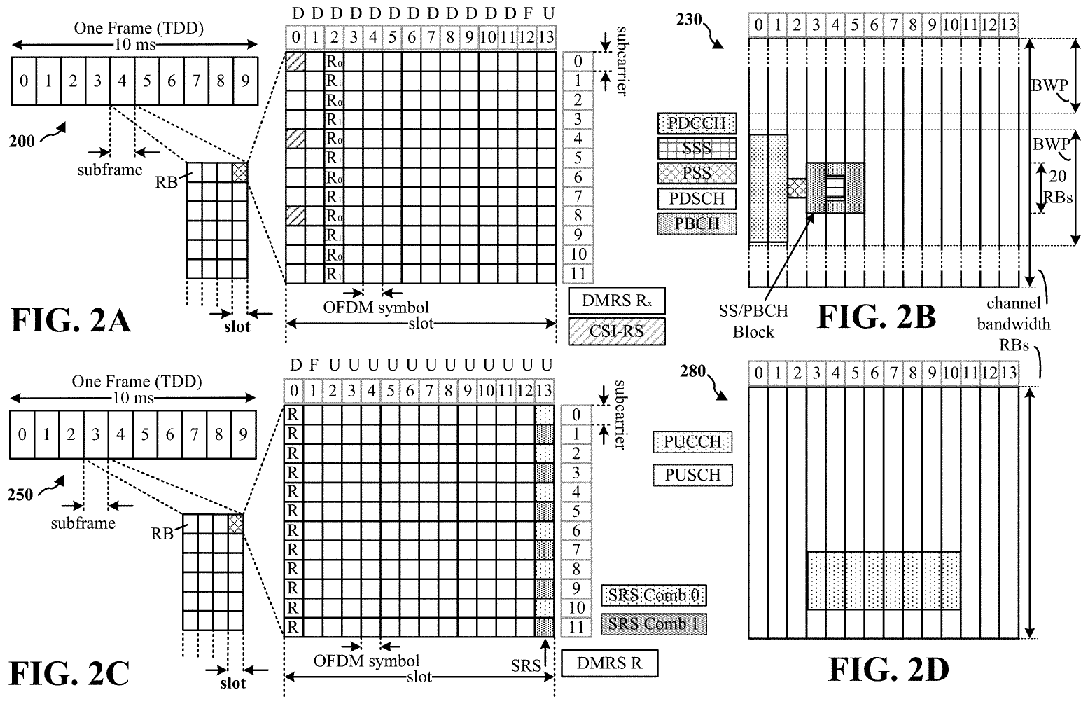

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

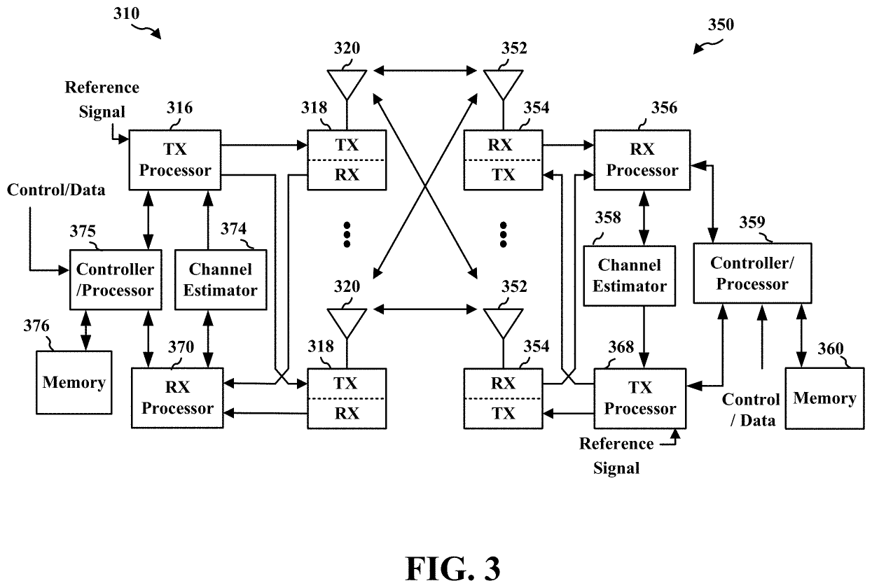

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the uplink gap configuration module 198 of FIG. 1.

At least one of the TX processor 316, the RX processor 370, and the controller/processor 375 may be configured to perform aspects in connection with uplink gap configuration module 199 of FIG. 1.

### Example Uplink Gap Configurations

As discussed, a base station may provide a UE with information for configuring an uplink gap at the UE. For example, the base station may provide the UE with one or more uplink gap patterns (ULGPs), as well as an uplink gap length (UGL) and uplink gap repetition periodicity (UGRP) corresponding to each of the one or more ULGPs. For instance, the UGL may indicate a number of consecutive static uplink slots configured as an uplink gap, per UGRP. For example, if the UE is communicating using a 120 kHz subcarrier spacing (SCS) (e.g., wherein the duration of each slot is ⅛ milliseconds (ms)), the UGRP is 20 ms, and the UGL is 1 ms, then the UE may use eight consecutive static uplink slots every 20 ms to perform an uplink gap process. Table 1 below is an example of four uplink gap configurations.

TABLE 1

| | UGL (ms) | UGRP (ms) | UGL/UGRP |
|---|---|---|---|
| ULGP#0 | 1.0 | 20 | 5% |
| ULGP#1 | 1.0 | 40 | 2.5% |
| ULGP#2 | 0.5 | 160 | ~0.31% |
| ULGP#3 | 0.125 | 5 | 2.5% |

Here, the UGL indicates the number of consecutive static uplink slots that can be configured as uplink gap slots, per UGRP. The base station may configure and/or de-configure the UE with the uplink gap configurations via a radio resource control (RRC) configuration message. However, in some examples, the base station may configure and/or de-configure the UE with the uplink gap configurations, and/or activate an uplink gap configuration via a medium access control (MAC) command transmitted to the UE. In some examples, the base station may configure the UE for uplink gap via RRC messaging and may activate the uplink gap configuration via MAC command. For example, the base station may activate an uplink gap capability at a given UE by providing it with one or more uplink gap configurations.

In certain aspects, the UE can explicitly indicate to the base station a “need for uplink gap” and/or “no need for uplink gap.” For example, the UE may transmit the indication to the base station via uplink control (e.g., physical uplink control channel (PUCCH), uplink control information (UCI)) or uplink shared channel (e.g., physical uplink shared channel (PUSCH)). In some examples, the “need for uplink gap” may be used by the UE as a request for uplink gap configuration. The UE may perform uplink gap processes once the uplink gap is configured and activated at the UE. The uplink gap processes may include BPS sensing and any other suitable self-calibration and/or self-monitoring process during the uplink gap slot. That is, the UE may refrain from using a downlink slot or special slot as an uplink gap slot.

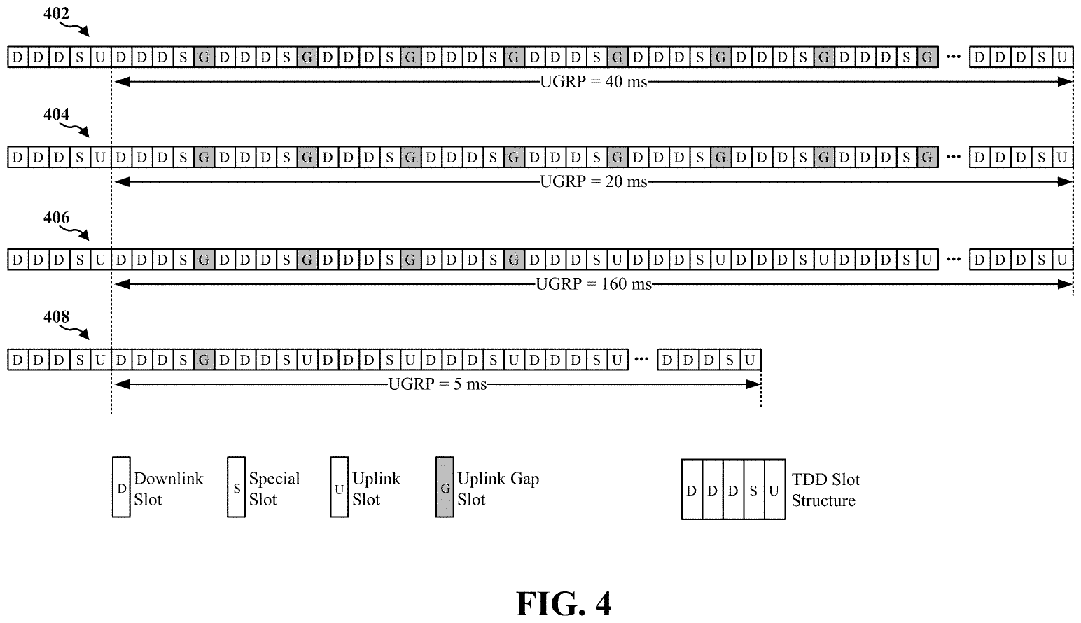

FIG. 4 is a block diagram illustrating example uplink gap slots for each of the four UGLPs of Table 1. Here, each of the four TDD slot structures illustrated use a DDDSU (downlink-downlink-downlink-special-uplink) TDD slot configuration at 120 KHz SCS. Shaded slots labeled as “G” correspond to slots used for UL gap according to each ULGP. Slots labeled “D” are downlink slots, “U” are uplink slots, and “S” are special slots.

A first TDD frame structure 402 is illustrated using ULGP #0 of Table 1 above. Here, because the length of one slot in the 120 kHz numerology is ⅛ ms, and the UGL is 1 ms, the total number of consecutive uplink slots that can be used as uplink gap slots is 8 (0.125 ms×8=1 ms). Thus, the UE may use a total of 8 uplink slots as uplink gap slots every periodic 40 ms time window (e.g., UGRP=40 ms for ULGP #0).

A second TDD frame structure 404 is illustrated using ULGP #1 of Table 1 above. Here, similar to ULGP #0, the UGL is 1 ms, meaning that the total number of consecutive uplink slots that can be used as uplink gap slots is 8. Thus, the UE may use a total of 8 uplink slots as uplink gap slots every periodic 20 ms time window (e.g., UGRP=20 ms for ULGP #1).

A third TDD frame structure 406 is illustrated using ULGP #2 of Table 1 above. Here, because the UGL is 0.5 ms, the total number of consecutive uplink slots that can be used as uplink gap slots is 4 (0.125 ms×4=1 ms). Thus, the UE may use a total of 4 uplink slots as uplink gap slots every periodic 160 ms time window (e.g., UGRP=160 ms for ULGP #2).

A fourth TDD frame structure 408 is illustrated using ULGP #3 of Table 1 above. Here, because the UGL is 0.125 ms, the total number of consecutive uplink slots that can be used as uplink gap slots is 1. That is, the UE may use 1 uplink slot as an uplink gap slots every periodic 5 ms time window (e.g., UGRP=5 ms for ULGP #3).

It should be noted that the values provided in Table 1 are examples, and any other suitable values may also be used. For example, the UE may use any number of consecutive UL gap slots for a UGRP so long as the aggregated duration of the number of consecutive uplink gap slots is equal to or less than the UGL, and the number of consecutive uplink gap slots fit within the periodic time window (e.g., UGRP). Moreover, it should be noted that the numerology (e.g., 120 kHz) and TDD slot structure of FIG. 4 may be changed to any suitable numerology or SCS (e.g., 120 kHz, 60 kHz, etc.), as well as any suitable TDD slot structure.

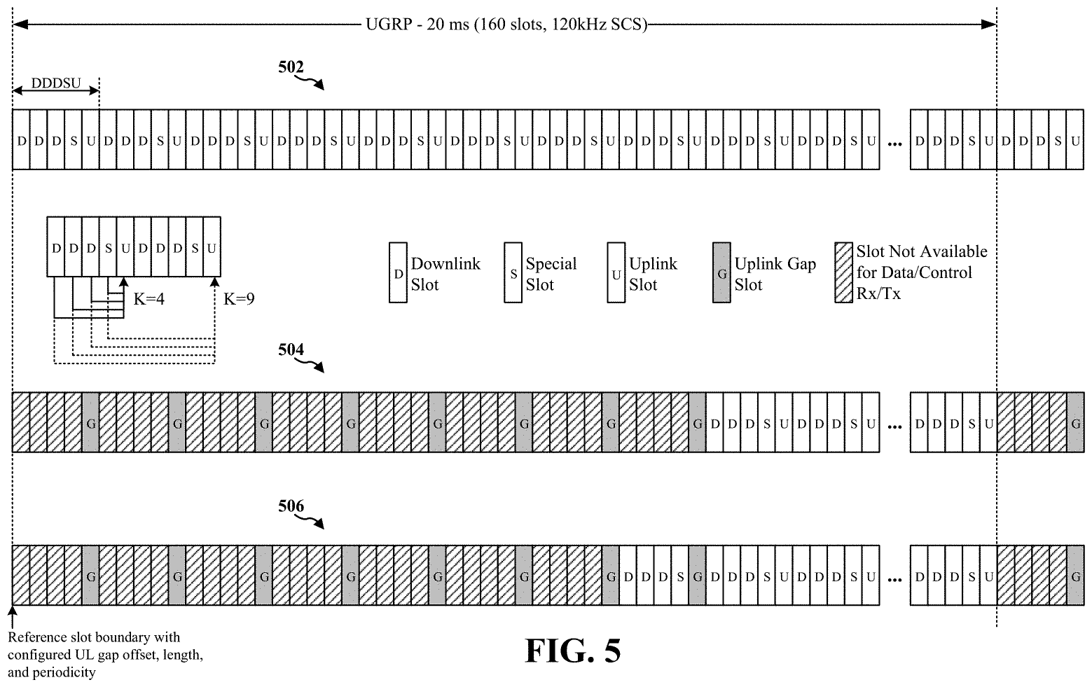

FIG. 5 is a block diagram illustrating example TDD slot structures and corresponding communication impacts caused by uplink gap slots. Here, as in FIG. 4, the TDD slot structures illustrated use the DDDSU (downlink-downlink-downlink-special-uplink) TDD slot configuration at 120 KHz SCS. Shaded slots labeled as “G” correspond to the slots used for UL gap according to each ULGP. Slots labeled “D” are downlink slots, “U” are uplink slots, and “S” are special slots. Slots not available for downlink communication (e.g., data and/or control signals) are illustrated with a diagonal cross-hatching pattern.

A first TDD frame structure 502 is provided as a reference structure. Here, the first TDD frame structure 502 uses the DDDSU TDD configuration, and begins at a reference slot boundary. A second TDD frame structure 504 is provided illustrating an example impact of ULGP #0 with K1 up to 4 on communications over the reference structure. A third TDD frame structure 506 is provided illustrating an example impact of ULGP #0 with K1 up to 9 on communications over the reference structure. Here, K1 is an offset between a downlink slot where data is scheduled (e.g., on PDSCH) and an uplink slot where the ACK/NACK feedback for the scheduled downlink data should be sent. For example, if K1=4, then an ACK/NACK should be sent in an uplink slot for corresponding data that was scheduled 4 or less slots prior to the uplink slot. If K1=9, then an ACK/NACK should be sent in an uplink slot for corresponding data that was scheduled 9 or less slots prior to the uplink slot.

As noted, ULGP #0 is used for the second TDD frame structure 504. As such, the UGL is 1 ms, and the UGRP is 20 ms. Because of the 120 kHz SCS used in this example, the UGL translates to 8 uplink slots that can be used as uplink gap slots, and the UGRP translates to a 160-slot periodic time window. Because K1=4 for the second TDD frame structure 504, the UE may be required to transmit an ACK/NACK for a downlink transmission no more than four slots following the downlink slot of the downlink transmission.

However, because uplink slots are used as uplink gap slots in a consecutive manner, the first eight uplink slots within the 160-slot UGRP are used as uplink gap slots. As such, the UE may not be able to transmit an ACK/NACK to any downlink data transmitted by the base station to the UE over the downlink slots that occur prior to the uplink gap slots. Although the UE may still receive and decode the downlink transmissions, the uplink gap slots may prevent the UE from transmitting any ACK/NACK in response. Thus, by committing the first eight uplink slots of the UGRP to uplink gap slots, the UE has effectively rendered the first twenty-four downlink slots unavailable for transmission of data. As a result, the beginning of each UGRP may be unavailable for downlink and uplink transmissions, which can negatively affect data communication and throughput between the UE and base station.

Similarly, the third TDD frame structure 506 uses ULGP #0, an SCS of 120 kHz, and the same TDD configuration as the reference structure. However, for the third TDD frame structure 506, K1=9. As such, it should be noted that the third TDD frame structure 506 includes three more available downlink slots than the second TDD frame structure 504 due to the higher K1 offset value.

The second TDD frame structure 504 and the third TDD frame structure 506 illustrate the negative impact on data communication and throughput between the UE and base station due to with uplink gap slots. Specifically, by using a consecutive scheduling of uplink gap slots, large duration of time are formed during which the UE cannot respond to downlink communications. As discussed, the UE and the base station may use certain timers to control aspects of wireless communication between the devices. The timers may include timer-based bandwidth part (BWP) switching, discontinuous reception (DRX) timers, time alignment (TA) timers, etc. However, an uplink gap process may prevent the UE from providing the base station with uplink data in response to a timer expiring. As such, the uplink gap process may result in a failed connection or communication between the UE and the base station.

Thus, techniques for reducing the number of unavailable slots for downlink communications would reduce the negative impact caused by scheduling consecutive uplink gap slots.

### Example Uplink Gap Distributions

In certain aspects, the UE may uniformly distribute uplink gap slots to uplink slots within an ULGP based on TDD uplink/downlink configuration and an activated uplink gap pattern (e.g., ULGP).

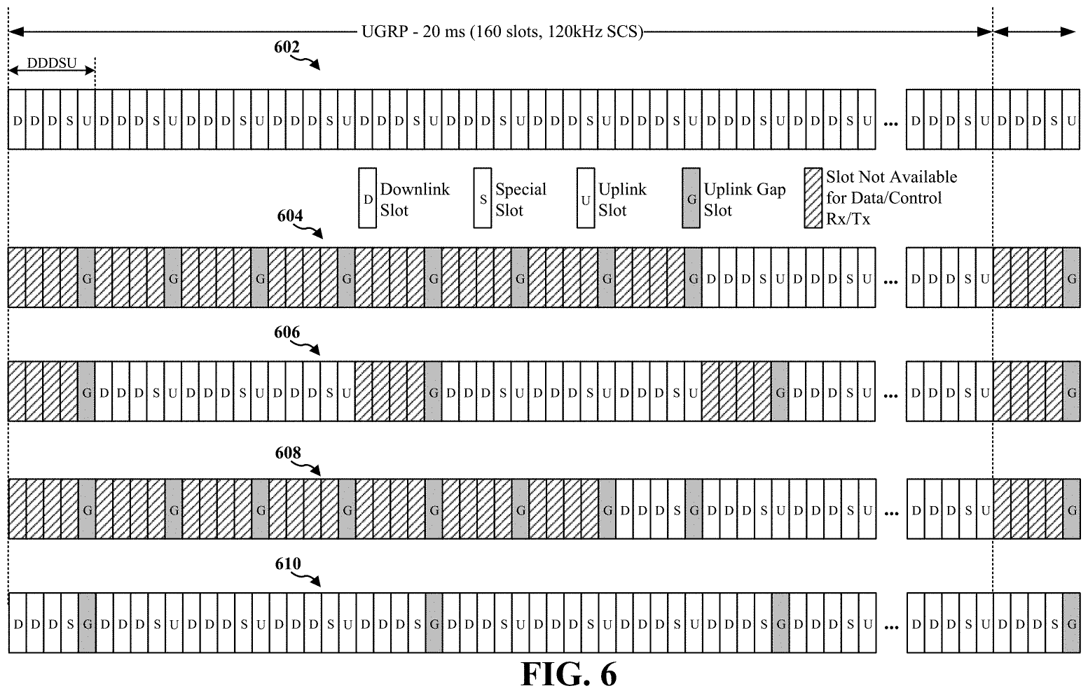

FIG. 6 is a block diagram illustrating example uplink gap distributions in an example TDD slot configuration. For example, a first TDD frame structure 602 provides a reference frame structure defined by a TDD configuration of DDDSU and a 120 kHz SCS. The following frame structures of FIG. 6 may use the same TDD configuration and SCS. Similar to the example of FIG. 5, the UGRP is a 20 ms duration for ULGP #0, and 8 uplink gap slots (e.g., 1 ms UGL) are provided for the UGRP.

A second TDD frame structure 604 and a third TDD frame structure 606 are provided illustrating a comparison of different uplink gap distributions using ULGP #0 with a K1 value of up to 4 on communications over the reference frame structure. Here, both the second TDD frame structure 604 and a third TDD frame structure 606 are configured with K1=4. Thus, the second TDD frame structure 604 is similar to the second TDD frame structure 504 of FIG. 5. That is, the uplink gap slots are mapped to eight consecutive uplink slots at the start of the UGRP, and the first twenty-four downlink slots are rendered unavailable.

However, as illustrated in the third TDD frame structure 606, instead of mapping uplink gaps to the first 8 consecutive uplink slots, the UE may distribute the uplink gaps within the full duration of the 20 ms UGRP. For example, as illustrated in the third TDD frame structure 606, the first uplink slot may be used as an uplink gap slot, and every fourth uplink slot thereafter may be used as an uplink gap slot. Accordingly, the UE may still map 8 uplink gaps to uplink slots within the UGRP, but in this example, the 8 uplink gaps are uniformly distributed throughout the UGRP (e.g., even distribution pattern of uplink gap slots).

Because of the low K1 value, certain downlink slots may still be unavailable for communication between the UE and the base station. However, by distributing the uplink gap slots, the UE may avoid the relatively long durations of unavailable slots shown in the second TDD frame structure 604. As discussed, the relatively long durations of unavailable slots can prevent UE from responding to timers or receiving downlink data for a relatively long period of time. Moreover, such a long duration may prevent a UE from performing according to quality of service (QoS) requirements (e.g., latency, priority, reliability, etc.) associated with the communication.

A fourth TDD frame structure 608 and a fifth TDD frame structure 610 are provided illustrating a comparison of different uplink gap distributions using ULGP #0 with K1 value of up to 9 on communications over the reference frame structure. Here, both the fourth TDD frame structure 608 and the fifth TDD frame structure 610 are configured with K1=9. Thus, the fourth TDD frame structure 608 is similar to the third TDD frame structure 506 of FIG. 5. That is, the uplink gap slots are mapped to eight consecutive uplink slots at the start of the UGRP, and the first twenty-one downlink slots are rendered unavailable.

However, as illustrated in the fifth TDD frame structure 610, instead of mapping uplink gaps to the first 8 consecutive uplink slots, the UE may distribute the uplink gaps within the full duration of the 20 ms UGRP. For example, as illustrated in the fifth TDD frame structure 610, the first uplink slot may be used as an uplink gap slot, and every fourth uplink slot thereafter may be used as an uplink gap slot. Accordingly, the UE may still map 8 uplink gaps to uplink slots within the UGRP, but in this example, the 8 uplink gaps are uniformly distributed throughout the UGRP (e.g., even distribution pattern of uplink gap slots).

Thus, the with an even distribution, all of the downlink slots are available for transmission by the base station because the UE can transmit an ACK/NACK with the K1=9 offset. Accordingly, the UE can still receive downlink transmissions throughout the UGRP, and the UE can still respond to expiring timers and meet QoS requirements associated with a communication with the base station.

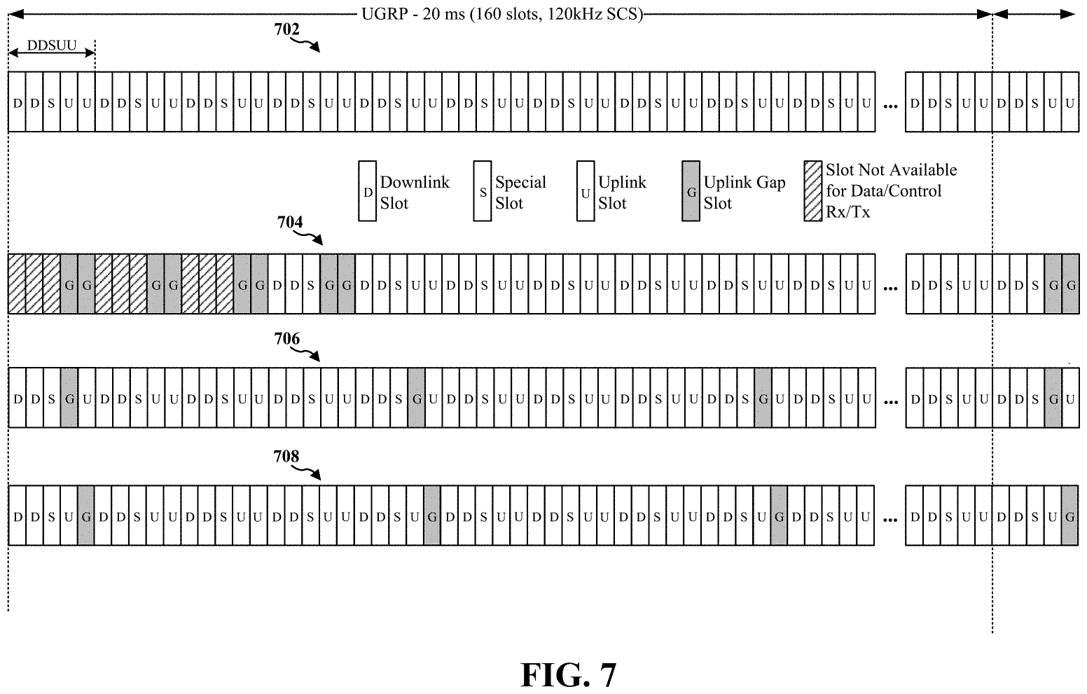

FIG. 7 is a block diagram illustrating example uplink gap distributions in an example TDD slot configuration. For example, a first TDD frame structure 702 provides a reference frame structure defined by a TDD configuration of DDSUU and a 120 kHz SCS. The following frame structures of FIG. 7 may use the same TDD configuration and SCS. Similar to the examples of FIGS. 5 and 6, the UGRP is a 20 ms duration for ULGP #0, and 8 uplink gap slots (e.g., 1 ms UGL) are provided for the UGRP. It should be noted that the TDD slot configuration illustrated in FIG. 7 includes two contiguous uplink slots. In this example, the K1 offset for each of the TDD frame structures is equal to 9.

A second TDD frame structure 704 is provided to illustrate an example result of front loading the uplink slots of the UGRP with uplink gap slots. In this example, due to the UE mapping uplink gaps to the first 8 consecutive uplink slots, six downlink slots are rendered unavailable for downlink communications.

However, as illustrated in the third TDD frame structure 706, instead of mapping uplink gaps to the first 8 consecutive uplink slots, the UE may distribute the uplink gaps within the full duration of the 20 ms UGRP. For example, as illustrated in the third TDD frame structure 706, the first uplink slot may be used as an uplink gap slot, and every fourth uplink slot thereafter may be used as an uplink gap slot. Accordingly, the UE may still map 8 uplink gaps to uplink slots within the UGRP, but in this example, the 8 uplink gaps are uniformly distributed throughout the UGRP (e.g., even distribution pattern of uplink gap slots).

Similarly, as illustrated in a fourth TDD frame structure 708, the UE may instead map uplink gaps to a later uplink slot of the two contiguous slots. In certain aspects, unless instructed otherwise by the base station, the UE may map the uplink gaps to a later uplink slot of the two contiguous uplink slots so that the UE may transmit an ACK/NACK relatively earlier than if the ACK/NACK were transmitted in the later uplink slot of the two contiguous uplink slots (as illustrated in the third TDD frame structure 706).

In certain aspects, the base station may configure the UE with a particular offset value configured to indicate which of two or more contiguous uplink slots the UE should use for uplink gap. Alternatively, if the base station does not provide the particular offset, the UE may select which of the two or more contiguous uplink slots to use for uplink gap.

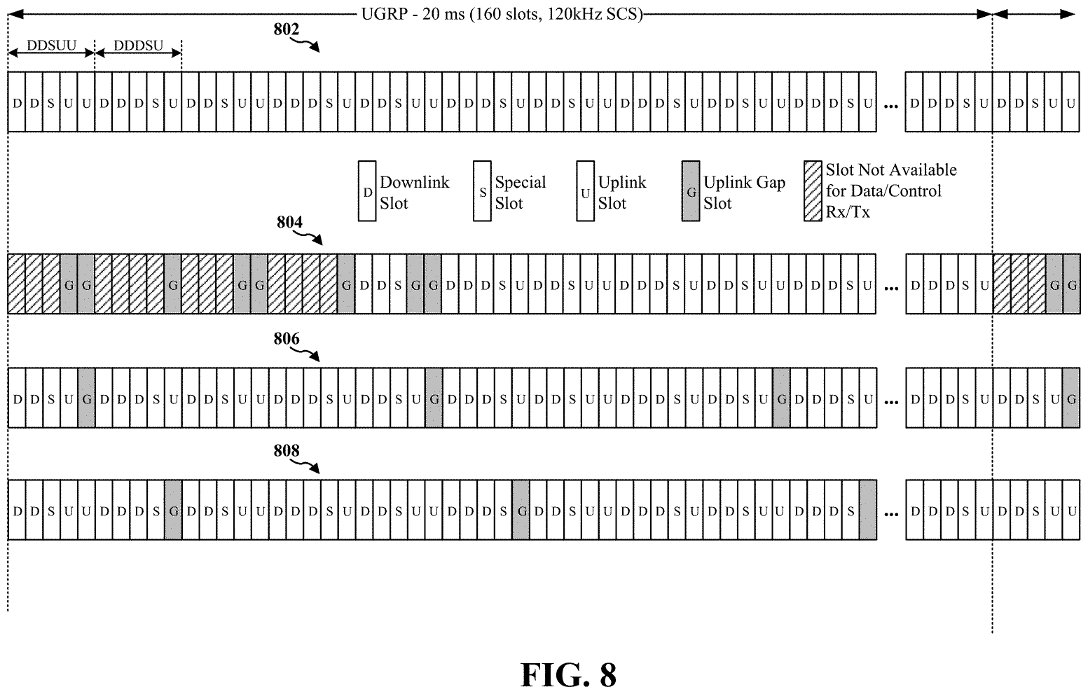

FIG. 8 is a block diagram illustrating example uplink gap distributions in an example TDD slot configuration. For example, a first TDD frame structure 802 provides a reference frame structure defined by a TDD configuration comprised of two slot patterns: DDSUU and DDDSU. That is, one of the slot patterns includes two contiguous uplink slots, and the other slot pattern only includes a single uplink slot. The following frame structures of FIG. 8 may use the same TDD configuration and 120 kHz SCS. Similar to the examples of FIGS. 5-7, the UGRP is a 20 ms duration for ULGP #0, and 8 uplink gap slots (e.g., 1 ms UGL) are provided for the UGRP. In this example, the K1 offset for each of the TDD frame structures is equal to 9.

A second TDD frame structure 804 illustrates an example of a front-loaded UGRP, wherein the UE maps the uplink gaps to the first eight uplink slots. As a result, at least ten downlink slots are unavailable due to the UE not being able to respond to received data with an ACK/NACK.

A third TDD frame structure 806 illustrates an example wherein if the TDD slot configuration includes two or more slot patterns, and if at least two of the two or more slot patterns have a different number of uplink slots, the UE may map an uplink gap to the last in time uplink slot within the consecutive uplink slots of the pattern that has more uplink slots than the other.

A fourth TDD frame structure 808 illustrates an example wherein if the TDD slot configuration includes two or more slot patterns, and if at least two of the two or more slot patterns have the same number of uplink slots, the UE may map the uplink gap to uplink slots in order to establish a uniform (e.g., even) distribution of uplink gaps within the UGRP.

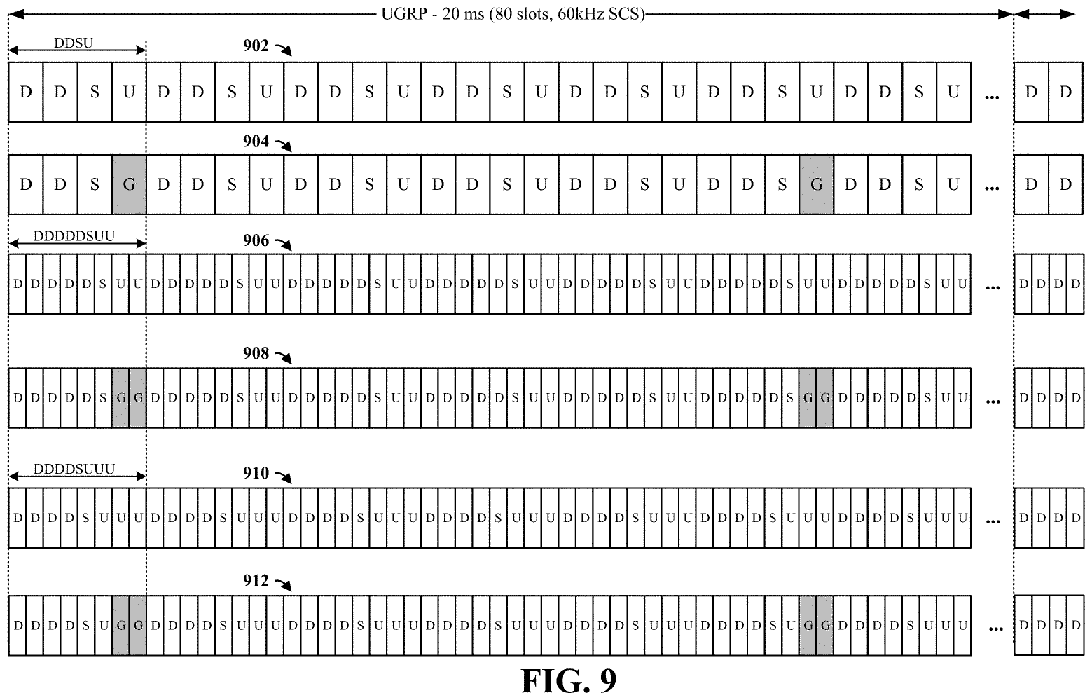

FIG. 9 is a block diagram illustrating example uplink gap distributions in example TDD slot configurations and SCS configurations. For example, a first TDD frame structure 902 provides a reference frame structure defined by a 60 kHz SCS and a TDD configuration comprised of a single slot pattern: DDSU.

A second TDD frame structure 904 is similarly defined by a 60 kHz SCS and a TDD configuration comprised of a single slot pattern: DDSU. In this example, the UE is configured with ULGP #0 for uplink gap mapping. Accordingly, the UGRP is a 20 ms duration for ULGP #0, and 4 uplink gap slots (e.g., 1 ms UGL at 60 kHz) are provided for the URGP. In this example, the K1 offset is equal to 7.

In this example, the UE may distribute the uplink gaps evenly throughout the UGRP. That is the UE may assign a first uplink gap at the first in time uplink slot of the URGP, then assign an uplink gap to every fifth uplink slot thereafter. Such a uniform distribution of uplink gaps prevent the UE from rendering any downlink slots unavailable for downlink communication. In this example, the second TDD frame structure may reflect a TDD configuration of a first bandwidth part (BWP). The base station may configure the UE with multiple BWPs including the first BWP, wherein the one or more of the multiple BWPs may rely on a different SCS relative to another BWP. In this example, the UE may be configured with the first BWP (e.g., a 60 kHz SCS) and a second BWP having a 120 kHz SCS.

A third TDD frame structure 906 illustrates an example of the second BWP, wherein the third TDD frame structure 906 is defined by a 120 kHz SCS and a TDD configuration comprised of a single slot pattern: DDDDDSUU. Thus, in this example, the UE is configured with multiple BWPs having different SCSs (60 kHz and 120 kHz). In one example, the UE may map uplink gaps based on the lowest SCS of the multiple BWPs, regardless of whether the BWP with the lowest SCS is active. Accordingly, if the UE switches from the first BWP to the second BWP, or vice versa, during a UGRP, the uplink gap pattern will remain the same (e.g., same timing across BWPs) after the BWP switching. This provides the benefit of not requiring the UE to reschedule self-calibration and/or self-monitoring processes that it performs during the uplink gap slots. A fourth TDD frame structure 908 illustrates an example of the UE using the same uplink gap pattern for the second BWP as the first BWP. A fifth TDD frame structure 910 and a sixth TDD frame structure 912 provide additional examples of a possible TDD frame structure of a third BWP.

In some examples, the UE may be configured with carrier aggregation (CA) in a frequency range (e.g., FR2), wherein a first carrier uses a first SCS (e.g., 60 kHz) and a second carrier uses a second SCS (e.g., 120 kHz). In this example, the UE may map uplink gaps based on the lowest SCS among active cells having active BWPs. In this way, the UE may configure an uplink gap pattern that may be applied to other BWPs and other carriers without requiring the UE to reschedule self-calibration and/or self-monitoring processes that it performs during the uplink gap slots.

As discussed, the UE may be configured with multiple BWPs of which use different subcarrier spacing (SCS). For example, the UE may be configured with an active first BWP that uses a 120 kHz SCS, and a non-active second BWP that uses a 60 kHz SCS. In this example, if the UE changes from the first BWP to the second BWP, the UE may simply scale down the number of uplink slots used for uplink gap processes. For example, the UE may be configured to use a maximum of eight uplink slots for an uplink gap process within one UGRP using the first BWP using the 120 kHz SCS and any of ULGP #0 or ULGP #1. Accordingly, if the UE switches to the second BWP that uses the 60 kHz SCS, the UE may simply scale down the maximum number of eight slots to four slots for the same UGRP. If the UE switches from the second BWP to the first BWP, then the UE may simply scale up the number of uplink gaps. The scaling down/up works here because the UGL is the same for both the first BWP and the second BWP, and because the UGL is greater than a slot length for both the 120 kHz and 60 kHz SCSs. Similarly, for ULGP #2, the UE may scale down or up the number of uplink gaps.

However, there may be cases when UGL is shorter than a slot length with respect to an SCS for an activated BWP. For example, in ULGP #3 a first BWP may be associated with a 0.125 ms UGL (e.g., a single uplink gap slot within the UGRP) for a 120 kHz SCS. In this case, the UE will not be able to switch to the second BWP that uses a 60 kHz SCS and maintain the same uplink gap pattern used in the first BWP. This is because the second BWP uses a 60 kHz SCS, and each slot of the 60 kHz SCS is greater than 0.125 ms. Thus, the UE would not be able to use a full uplink slot for the uplink gap, because the 0.125 ms would only provide for half of an uplink slot at 60 kHz, which would render the entire slot unavailable. Thus, in such a case, the UE may scale up the UGL when the UGL is shorter than a slot length with respect to a particular SCS. Table 2 is provided below as an example for scaling up.

TABLE 2

| | SCS of | | | | | |
|---|---|---|---|---|---|---|
| | active | UGL | | UGRP | | |
| ULGP | BWP | ms | #slots | ms | #slots | UGL/UGRP |
| ULGP#0 | 120 kHz | 1 | 8 | 20 | 160 | 5% |
| | 60 kHz | 1 | 4 | 20 | 80 | 5% |
| ULGP#1 | 120 kHz | 1 | 8 | 40 | 320 | 2.5% |
| | 60 kHz | 1 | 4 | 40 | 160 | 2.5% |
| ULGP#2 | 120 kHz | 0.5 | 4 | 160 | 1280 | −0.31% |
| | 60 kHz | 0.5 | 2 | 160 | 640 | −0.31% |
| ULGP#3 | 120 kHz | 0.125 | 1 | 5 | 40 | 2.5% |
| | A: | 0.25 | 1 | 5 | 20 | 5% |
| | 60 kHz | | | | | |
| | B: | 0.25 | 1 | 10 | 40 | 2.5% |
| | 60 kHz | | | | | |

As shown in table 2, each ULGP is associated with at least one 120 kHz SCS and at least one 60 kHz SCS. As discussed, for ULGP #0-2, the UE may simply scale up or down if the UE is switching from a first BWP to a second BWP that uses the same ULGP but a different SCS. However, because the UE will be unable to scale down from the 120 kHz SCS of ULGP #3 to a 60 kHz SCS of ULGP #3, certain aspects of the invention relate to scaling up from the 120 kHz SCS to a 60 kHz SCS.

As shown, option A is for a 60 kHZ SCS with a UGL of 0.25 ms (1 slot per UGRP) and a 5 ms UGRP (20 total slots per UGRP). Option B is for a 60 kHZ SCS with a UGL of 0.25 ms (1 slot per UGRP) and a 10 ms UGRP (40 total slots per UGRP). Thus, option A keeps the same periodicity (e.g., UGRP ms) between 120 kHz and 60 kHz and results in overhead (e.g., UGL/UGRP) for 60 kHz twice as large as for 120 kHz. The benefit of this is the uplink gap timing is the same for both 120 kHz and 60 kHz. Option B has the benefit of the reduced overhead relative to option A. Thus, when a UGL is shorter than a slot length with respect to the configured or activated SCS of a particular BWP, the configured UGL and UGRP may be scaled up, as shown in the example of Table 2. It should be noted that a UGL/UGRP ratio, shown in the right-most column, indicates an overhead of the uplink gap slots associated with each ULGP and SCS. In some examples the UE and/or base station may scale up the UGL until the UGL/UGRP ratio is within a threshold range. For example, the threshold range may be between 2.5% and 5%.

In certain aspects, a UE may determine whether it has a “need for uplink gap.” For example, the UE may determine whether to use an uplink gap during one or more uplink slots based on TDD slot configurations (e.g., uplink/downlink patterns that are RRC configured by the base station), active and/or configured BWPs (e.g., whether the active and/or configured BWPs have different SCSs, a reference SCS to determine whether and which UL gap pattern is needed is the lowest SCS among configured and/or activated UL BWPs across FR2 serving cells, and/or whether there is a benefit/gain that the UE and/or base station should expect from using an uplink gap). In some examples, the UE may estimate a benefit (e.g., improved RSRP, reduced number of unavailable slots, etc.) to communications with the base station based on a reference SCS, or an active BWP SCS.

In certain aspects, the base station can transmit a query to the UE to determine whether the UE can use an uplink gap configuration, and/or whether the UE is in a condition where using an uplink gap configuration would be beneficial. For example, if the UE can improve its communication with the base station by performing uplink gap processes, then the UE may request an uplink gap configuration from the base station. In some examples, the UE may request the uplink gap configuration without a query from the base station.

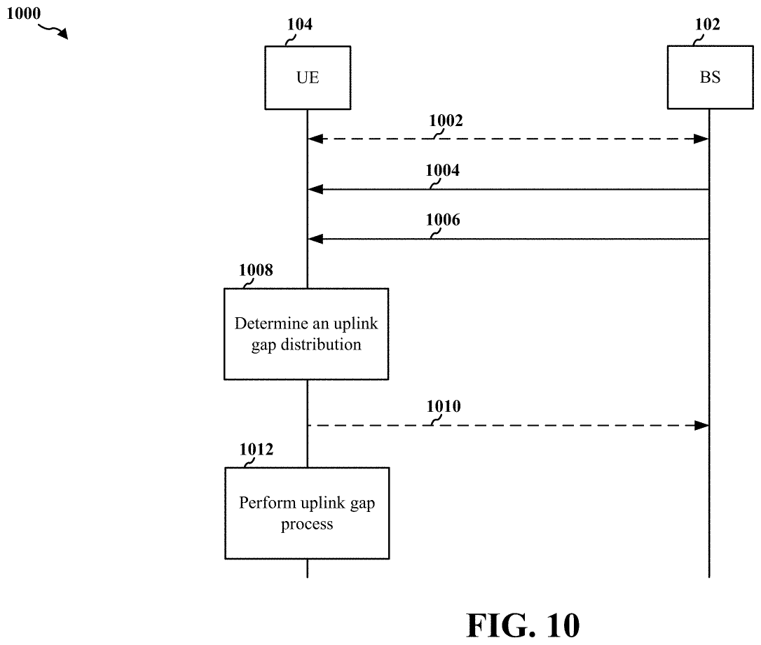

FIG. 10 is a call-flow diagram 1000 illustrating example communications between a UE (e.g., UE 104 of FIG. 1) and a base station (e.g., BS 102 of FIG. 1) for an uplink gap process.

At an optional first communication 1002, the base station 102 and UE 104 may coordinate and determine whether the UE 104 has a capability to use uplink gaps, and if the UE can improve its communications with the base station 102 using uplink gaps. For example, the base station 102 may transmit signaling to the UE 104 requesting the UE 104 provide one or more of a confirmation that it is capable of performing uplink gaps, and/or whether the UE-side communications can be improved by using uplink gaps (e.g., if the UE 104 can perform self-calibration and/or self-monitoring during the uplink gaps).

At a second communication 1004, the base station 102 may transmit a first TDD configuration for wireless communication between the UE 104 and the base station 102. The first TDD configuration may me a TDD uplink/downlink pattern that the UE 104 may use to communicate with the base station 102 over a BWP and/or a particular carrier in CA.

At a third communication 1006, the base station 102 may transmit an uplink gap pattern (ULGP) configuration indicating at least first ULGP associated with a first time window (e.g., a UGRP) and the first TDD configuration. For example, the base station 102 may transmit one or more ULGPs, wherein each of the ULGPs are associated with the corresponding first time window and UGL. In certain aspects, the third communication 1006 may include a slot offset value configured to offset a distribution of the one or more uplink gaps from one uplink slot to another uplink slot within the first time window.

At a first process 1008, the UE may determine, based on the first TDD configuration and the first ULGP, a distribution of one or more uplink gaps within the first time window. Here, the UE may determine whether to front-load uplink slots by mapping uplink gaps to the first consecutive uplink slots within the first time window, or whether to uniformly distribute the uplink gaps to uplink slots throughout the first time window.

At an optional fourth communication 1010, the UE 104 may transmit an indication of the uplink gap distribution determined at the first process 1008.

At a second process 1012, the UE 104 may apply the uplink gaps to uplink slots according to the determined distribution, and perform any suitable self-calibration and/or self-monitoring processes during the uplink gaps.

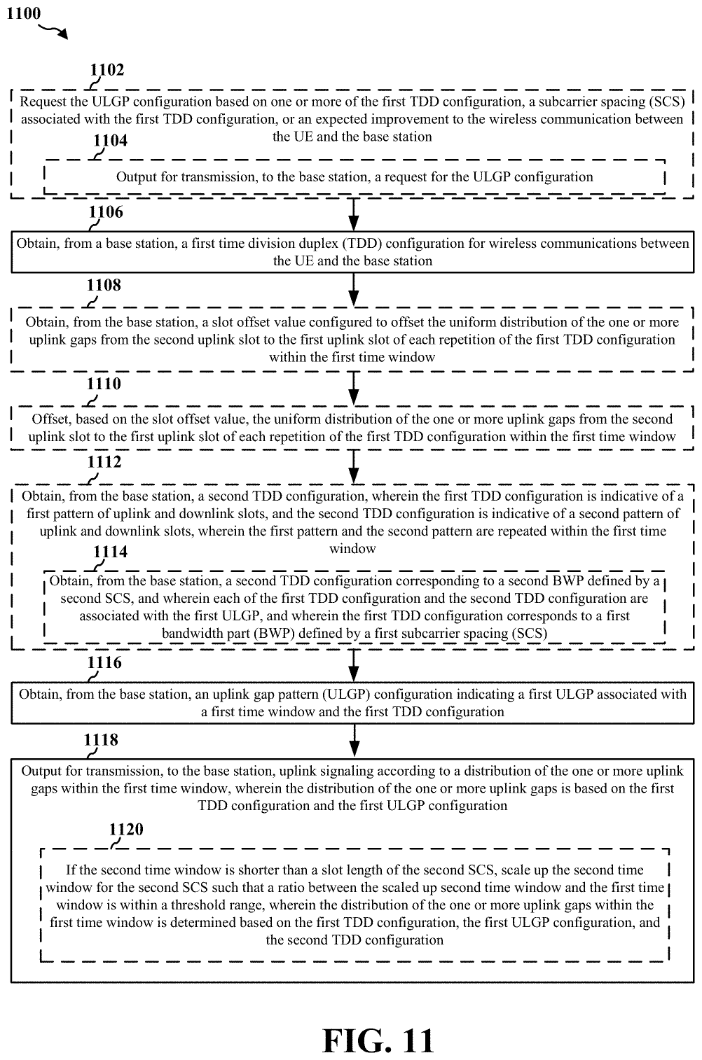

FIG. 11 is a flowchart 1100 of a method of wireless communication. The method may be performed by a UE (e.g., the UE 104; the apparatus 1202).

At a first step 1102, the UE may optionally request the ULGP configuration based on one or more of the first TDD configuration, a subcarrier spacing (SCS) associated with the first TDD configuration, or an expected improvement to the wireless communication between the UE and the base station. For example, the first step 1102 may be performed by a requesting component 1240. Here, the UE may first determine whether an uplink gap should be applied to one or more uplink slots in a communication link between the UE and the base station.

At a second step 1104, the UE may optionally output for transmission, to the base station, a request for the ULGP configuration. For example, the second step 1104 may be performed by an outputting component 1242. Here, if the UE determines that uplink gaps may improve its communication with the base station, then the UE may request ULGP configuration. For example, the UE may determine that the TDD configurations and/or BWPs it is configured with would allow the UE to perform the uplink gap processes without making any downlink slots unavailable, or only a small number of downlink slots unavailable. That is, the communication parameters of the UE may allow the UE to distribute uplink gaps in the manners shown in the examples of FIGS. 6-9.

At a third step 1106, the UE may obtain, from a base station, a first time division duplex (TDD) configuration for wireless communication between the UE and the base station. For example, the third step 1106 may be performed by an obtaining component 1244. Here, the TDD configuration may include a TDD pattern of uplink, downlink, and/or special slots that the UE may use in communication with the base station.

At a fourth step 1108, the UE may optionally obtain, from the base station, a slot offset value configured to offset the uniform distribution of the one or more uplink gaps from the second uplink slot to the first uplink slot of each repetition of the first TDD configuration within the first time window. For example, the fourth step 1108 may be performed by the obtaining component 1244. Here, the slot offset may include an offset value configured to indicate a number of slots that the UE should offset an uplink gap. For example, the offset may indicate that, for two contiguous uplink slots, the UE should map the uplink gap to the first or second of the two uplink slots.

At a fifth step 1110, the UE may optionally offset, based on the slot offset value, the uniform distribution of the one or more uplink gaps from the second uplink slot to the first uplink slot of each repetition of the first TDD configuration within the first time window. For example, the fifth step 1110 may be performed by the offsetting component 1248. For example, if the UE is configured with multiple contiguous uplink slots, the slot offset value may indicate which of the multiple contiguous uplink slots are to be used as an uplink gap.

At a sixth step 1112, the UE may optionally obtain, from the base station, a second TDD configuration, wherein the first TDD configuration is indicative of a first pattern of uplink and downlink slots, and the second TDD configuration is indicative of a second pattern of uplink and downlink slots, wherein the first pattern and the second pattern are repeated within the first time window. For example, the sixth step 1112 may be performed by the obtaining component 1244. In this example, the UE may be configured with multiple TDD patterns for communication with the base station, as illustrated in the example of FIGS. 8 and 9.

At a seventh step 1114, wherein the first TDD configuration corresponds to a first bandwidth part (BWP) defined by a first subcarrier spacing (SCS), the UE may obtain, from the base station, a second TDD configuration corresponding to a second BWP defined by a second SCS, and wherein each of the first TDD configuration and the second TDD configuration are associated with the first ULGP. For example, the seventh step 1114 may be performed by the obtaining component 1244. Here, the UE may be configured with two different TDD configurations (e.g., uplink/downlink patterns) where each of the two TDD configurations are associated with a different SCS.

At an eighth step 1116, the UE may obtain, from the base station, an uplink gap pattern (ULGP) configuration indicating a first ULGP associated with a first time window and the first TDD configuration. For example, the eighth step 1116 may be performed by the obtaining component 1244. Here, the ULGP configuration may be in response to the second step 1104. In some examples, the base station may determine without UE feedback that the UE should be configured for uplink gap. For example, the base station may determine that the TDD configurations and/or BWPs that the UE is configured with would allow the UE to perform the uplink gap processes without making any downlink slots unavailable, or only a small number of downlink slots unavailable. That is, the base station may configure the UE for uplink gaps if the communication parameters of the UE allow the UE to distribute uplink gaps in the manners shown in the examples of FIGS. 6-9.

At a ninth step 1118, the UE may output for transmission, to the base station, uplink signaling according to a distribution of the one or more uplink gaps within the first time window, wherein the distribution of the one or more uplink gaps is based on the first TDD configuration and the first ULGP configuration. For example, the ninth step 1118 may be performed by the outputting component 1242. Here, the UE may determine an even, or uniform, mapping of uplink gaps to uplink slots according to the first TDD configuration and the first ULGP configuration. In some examples, the determination may be a mapping that eliminates or reduces the number of downlink slots that are rendered unavailable because of the uplink gaps.

At a tenth step 1120, the UE may optionally, if the second time window is shorter than a slot length of the second SCS, scale up the second time window for the second SCS such that a ratio between the scaled up second time window and the first time window is within a threshold range, wherein the distribution of the one or more uplink gaps within the first time window is determined based on the first TDD configuration, the first ULGP configuration, and the second TDD configuration. For example, the tenth step 1120 may be performed by the scaling component 1246. For example, there may be a scenario where a UGL is shorter than a slot length with respect to an SCS for an activated BWP. For example, if a first BWP is associated with a 0.125 ms UGL (e.g., a single uplink gap slot within the UGRP), the UE will not be able to switch to the second BWP. This is because the second BWP uses a 60 kHz SCS, and each slot of the 60 kHz SCS is greater than 0.125 ms. Thus, the UE would not be able to use a full uplink slot for the uplink gap, because the 0.125 ms would only provide for half of an uplink slot, which would render the entire slot unavailable. Thus, in such a case, the UE may scale up the UGL when the UGL is shorter than a slot length with respect to a particular SCS.

In another example, referring to Table 2 above, mapping UGLP #0-2 to a physical TDD pattern is possible because the UE can scale the #slots according to a corresponding SCS (e.g., ULGP #0 can be scaled from 8 #slots in 1 ms at a 120 kHz SCS, to 4 #slots in 1 ms at 60 kHz). However, with ULGP #3, the #slots for 120 kHz cannot be scaled down to accommodate communications with ULGP #3 at 60 kHz SCS because the result is less than one slot for 60 kHz. Specifically, ULGP #3 with 120 kHz SCS has a #slot equal to 1, so for 60 kHz the #slot should be half that of 120 kHz; however, half a slot is invalid. Thus, because the UGL ms for 60 kHz is twice the UGL ms for 120 kHz the UE may not scale down the #slots/ms for ULGP #3. So, the UE may instead scale up the UGL for ULGP #3 at 60 kHz SCS. Thus, if the active BWP is 60 kHz SCS, the UE may adjust the UGL by scaling up. In some examples, scaling up the UGL may be done by keeping the same or similar ratio (UGL/UGRP) for ULGP #3 as for ULGP #0-2.

In certain aspects, the first time window is indicative of a repetition periodicity of the one or more uplink gaps for the first ULGP.

In certain aspects, the first ULGP is associated with a second time window indicative of a maximum aggregate duration of the one or more uplink gaps within the first time window.

In certain aspects, the distribution of the one or more uplink gaps within the first time window is a uniform distribution of the one or more uplink gaps to uplink symbols of the first TDD configuration within the first time window.

In certain aspects, the first TDD configuration is indicative of a pattern of uplink and downlink slots repeated within the first time window, and wherein the pattern of uplink and downlink slots comprises at least a first uplink slot and a second uplink slot contiguous to the first uplink slot.

In certain aspects, the distribution of the one or more uplink gaps is a uniform distribution of the one or more uplink gaps to the second uplink slot of each repetition of the first TDD configuration within the first time window, and wherein the second uplink slot occurs after the first uplink slot in the pattern of uplink and downlink slots.

In certain aspects, the second pattern comprises a number of uplink slots that is greater than a number of uplink slots of the first pattern, and the uplink slot of the second pattern is a last uplink slot of the second pattern.

In certain aspects, the first TDD configuration corresponds to a first bandwidth part (BWP) defined by a first subcarrier spacing (SCS), and each of the first TDD configuration and the second TDD configuration are associated with the first ULGP.

In certain aspects, the first ULGP is associated with a second time window indicative of a maximum aggregate duration of the one or more uplink gaps within the first time window.

In certain aspects, the distribution of the one or more uplink gaps within the first time window is determined based on a lower SCS of the first SCS and the second SCS regardless of which of the first BWP or the second BWP is active, and wherein a location of the one or more uplink gaps within the first time window based on the first SCS is the same location of the one or more uplink gaps within the first time window based on the second SCS.

In certain aspects, the request for the ULGP configuration is outputted for transmission in response to a signal, transmitted by the base station, querying the apparatus for an uplink gap determination, wherein the one or more processors are further configured to cause the apparatus to determine whether to request the ULGP configuration based on at least one of the first TDD configuration, a subcarrier spacing (SCS) associated with the first TDD configuration, or an expected improvement to the wireless communications between the apparatus and the base station.

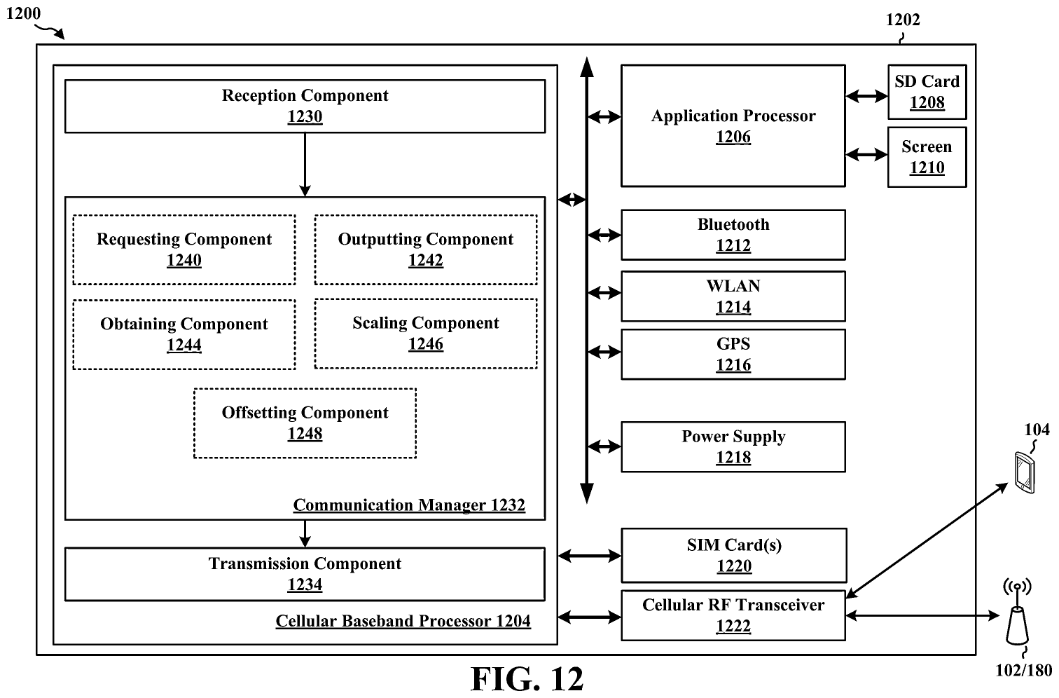

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see UE 350 of FIG. 3) and include the aforediscussed additional modules of the apparatus 1202.

The communication manager 1232 includes a requesting component 1240 that is configured to request the ULGP configuration based on one or more of the first TDD configuration, a subcarrier spacing (SCS) associated with the first TDD configuration, or an expected improvement to the wireless communication between the UE and the base station, as described in connection with the first step 1102 of FIG. 11.

The communication manager 1232 further includes an obtaining component 1244 that is configured to obtain, from a base station, a first time division duplex (TDD) configuration for wireless communications between the UE and the base station; obtain, from the base station, a slot offset value configured to offset the uniform distribution of the one or more uplink gaps from the second uplink slot to the first uplink slot of each repetition of the first TDD configuration within the first time window; obtain, from the base station, a second TDD configuration, wherein the first TDD configuration is indicative of a first pattern of uplink and downlink slots, and the second TDD configuration is indicative of a second pattern of uplink and downlink slots, wherein the first pattern and the second pattern are repeated within the first time window, obtain, from the base station, an uplink gap pattern (ULGP) configuration indicating a first ULGP associated with a first time window and the first TDD configuration, e.g., as described in connection with the third step 1106, the fourth step 1108, the sixth step 1112, and the seventh step 1114 of FIG. 11.

The communication manager 1232 further includes an outputting component 1242 configured to output for transmission, to the base station, a request for the ULGP configuration, and output for transmission, to the base station, uplink signaling according to the distribution of the one or more uplink gaps e.g., as described in connection with the second step 1104 and the tenth step 1120 of FIG. 11.

The communication manager 1232 further includes a scaling component 1246 configured to scale up the second time window for the second SCS such that a ratio between the scaled up second time window and the first time window is within a threshold range if the second time window is shorter than a slot length of the second SCS, wherein the distribution of the one or more uplink gaps within the first time window is determined based on the first TDD configuration, the first ULGP configuration, and the second TDD configuration, e.g., as described in connection with the tenth step 1120 of FIG. 11.

The communication manager 1232 further includes an offsetting component 1248 configured to offset, based on the slot offset value, the uniform distribution of the one or more uplink gaps from the second uplink slot to the first uplink slot of each repetition of the first TDD configuration within the first time window, e.g., as described in connection with the fifth step 1110 of FIG. 11.

The apparatus may include additional components that perform each of the blocks of the algorithm in the aforementioned flowcharts of FIG. 11. As such, each block in the aforementioned flowcharts of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for determining whether to request the ULGP configuration based on one or more of the first TDD configuration, a subcarrier spacing (SCS) associated with the first TDD configuration, or an expected improvement to the wireless communication between the UE and the base station; means for outputting for transmission, to the base station, a request for the ULGP configuration; means for obtaining, from a base station, a first time division duplex (TDD) configuration for wireless communications between the UE and the base station; means for obtaining, from the base station, a slot offset value configured to offset the uniform distribution of the one or more uplink gaps from the second uplink slot to the first uplink slot of each repetition of the first TDD configuration within the first time window; means for offsetting, based on the slot offset value, the uniform distribution of the one or more uplink gaps from the second uplink slot to the first uplink slot of each repetition of the first TDD configuration within the first time window; means for obtaining, from the base station, a second TDD configuration, wherein the first TDD configuration is indicative of a first pattern of uplink and downlink slots, and the second TDD configuration is indicative of a second pattern of uplink and downlink slots, wherein the first pattern and the second pattern are repeated within the first time window; means for obtaining, from the base station, an uplink gap pattern (ULGP) configuration indicating a first ULGP associated with a first time window and the first TDD configuration; means for determining, based on the first TDD configuration and the first ULGP configuration, a distribution of one or more uplink gaps within the first time window; means for determining that the second time window is shorter than a slot length of the second SCS; means for scaling up the second time window for the second SCS such that a ratio between the scaled up second time window and the first time window is within a threshold range, wherein the distribution of the one or more uplink gaps within the first time window is determined based on the first TDD configuration, the first ULGP configuration, and the second TDD configuration; and means for outputting for transmission, to the base station, uplink signaling according to the distribution of the one or more uplink gaps.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

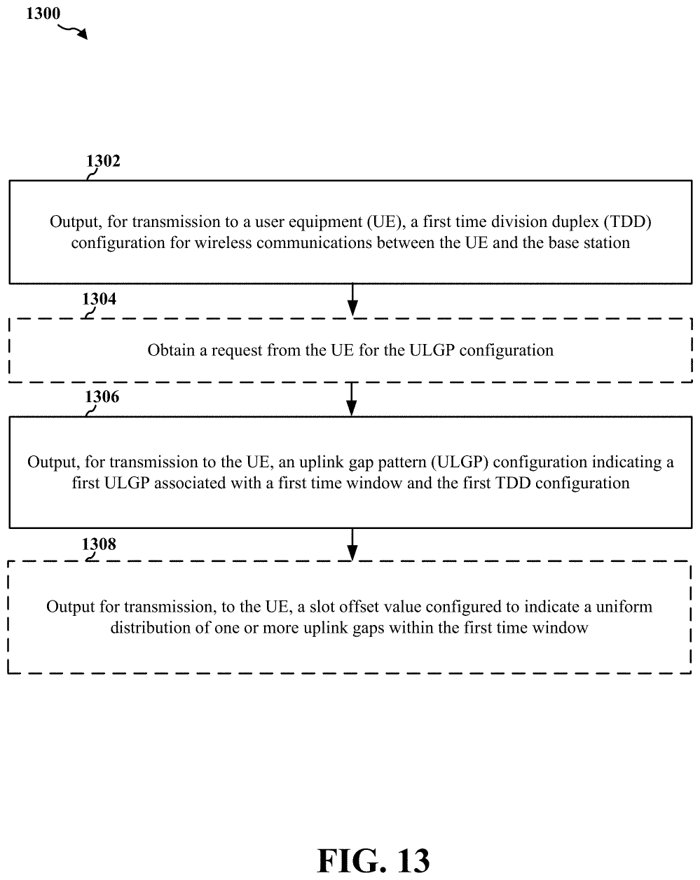

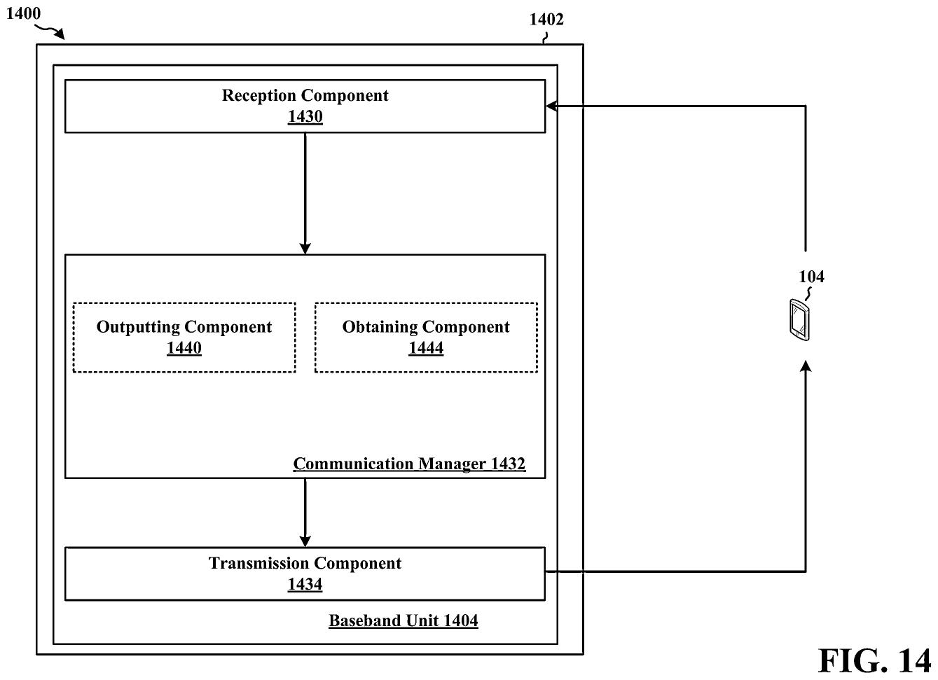

FIG. 13 is a flowchart 1300 of a method of wireless communication. The method may be performed by a base station (e.g., the base station 102/180; the apparatus 1402). At a first step 1302, the base station may output for transmission, to a user equipment (UE), a first time division duplex (TDD) configuration for wireless communications between the UE and the base station. For example, the first step 1302 may be performed by an outputting component 1440 of FIG. 14. Here, the base station may configure the UE with one or more TDD configurations (e.g., uplink/downlink slot pattern) for communication with the base station.

At a second step 1304, the base station may optionally obtain a request from the UE for an uplink gap pattern (ULGP). For example, the second step 1304 may be performed by an obtaining component 1444 of FIG. 14.

At a third step 1306, the base station may output, for transmission to the UE, an uplink gap pattern (ULGP) configuration indicating a first ULGP associated with a first time window and the first TDD configuration. For example, the third step 1306 may be performed by the outputting component 1440 of FIG. 14. Here, the base station may determine a ULGP based on a configuration of patterns such as those shown in Tables 1 and 2. In some examples, the base station may configure the UE with one or more ULGPs per BWP.

At a fourth step 1308, the base station may optionally output for transmission, to the UE, a slot offset value configured to indicate a uniform distribution of one or more uplink gaps within the first time window. For example, the fourth step 1308 may be performed by the outputting component 1440 of FIG. 14.

FIG. 14 is a diagram 1400 illustrating an example of a hardware implementation for an apparatus 1402. The apparatus 1402 is a BS and includes a baseband unit 1404. The baseband unit 1404 may communicate through a cellular RF transceiver with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

The communication manager 1432 includes an outputting component 1440 configured to output for transmission, to a user equipment (UE), a first time division duplex (TDD) configuration for wireless communications between the UE and the base station; output the ULGP configuration for transmission to the UE based on the determination to provide the UE with the ULGP configuration; output for transmission, to the UE, a slot offset value configured to indicate a uniform distribution of one or more uplink gaps within the first time window, e.g., as described in connection with the first step 1302, and the fourth step 1308 of FIG. 13.

The communication manager 1432 further includes an obtaining component 1444 configured to obtain a request from the UE for the ULGP configuration, e.g., as described in connection with the fourth step 1308 of FIG. 13.

The apparatus may include additional components that perform each of the blocks of the algorithm in the aforementioned flowcharts of FIG. 12. As such, each block in the aforementioned flowcharts of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the baseband unit 1404, includes means for outputting for transmission, to a user equipment (UE), a first time division duplex (TDD) configuration for wireless communications between the UE and the base station; means for obtaining a request from the UE for the ULGP configuration; means for determining to provide the UE with an uplink gap pattern (ULGP) configuration indicating a first ULGP associated with a first time window and the first TDD configuration; and means for outputting the ULGP configuration for transmission to the UE based on the determination to provide the UE with the ULGP configuration; and means for outputting for transmission to the UE, a slot offset value configured to indicate a uniform distribution of one or more uplink gaps within the first time window. The aforementioned means may be one or more of the aforementioned components of the apparatus 1402 configured to perform the functions recited by the aforementioned means. As described supra, the apparatus 1402 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### Additional Considerations

Means for receiving or means for obtaining may include a receiver (such as the receive processor 370 and/or receiver 318RX) and/or an antenna(s) 320 of the BS 310 or the receive processor 356, receiver 354RX, and/or antenna(s) 352 of the UE 350 illustrated in FIG. 3. Means for transmitting or means for outputting may include a transmitter (such as the transmit processor 316 and/or transmitter 318TX) and/or an antenna(s) 320 of the BS 310 and/or the transmit processor 368, transmitter 354TX, and/or antenna(s) 352 of the UE 350 illustrated in FIG. 3. Means for scaling, means for offsetting, means for determining, and/or means for performing may include a processing system, which may include one or more processors, such as the receive processor 370/356, the transmit processor 316/368, the controller 375/359 of the BS 310 and the UE 350 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” (or any variants thereof such as “determine”) may encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), resolving, selecting, choosing, establishing and the like.

As used herein, the term “scaling” (or any variants thereof such as “scale”) may encompass a wide variety of actions. For example, “scaling” may include calibrating, proportioning, reducing/expanding according to a ratio, sizing, and the like.

As used herein, the term “offsetting” (or any variants thereof such as “offset”) may encompass a wide variety of actions. For example, “offsetting” may include calibrating, compensating, changing in size and/or time, balancing, and the like.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and A, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communications at a user equipment (UE), comprising: obtaining, from a base station, a first time division duplex (TDD) configuration for wireless communications between the UE and the base station; obtaining, from the base station, an uplink gap pattern (ULGP) configuration indicating a first ULGP associated with a first time window and the first TDD configuration; determining, based on the first TDD configuration and the first ULGP configuration, a distribution of one or more uplink gaps within the first time window; and outputting for transmission, to the base station, uplink signaling according to the distribution of the one or more uplink gaps.

Example 2 is the method of example 1, wherein the first time window is indicative of a repetition periodicity of the one or more uplink gaps for the first ULGP.

Example 3 is the method of any of examples 1 and 2, wherein the first ULGP is associated with a second time window indicative of a maximum aggregate duration of the one or more uplink gaps within the first time window.

Example 4 is the method of any of examples 1-3, wherein the distribution of the one or more uplink gaps within the first time window is a uniform distribution of the one or more uplink gaps to uplink symbols of the first TDD configuration within the first time window.

Example 5 is the method of any of examples 1-4, wherein the first TDD configuration is indicative of a pattern of uplink and downlink slots repeated within the first time window, and wherein the pattern of uplink and downlink slots comprises at least a first uplink slot and a second uplink slot contiguous to the first uplink slot.

Example 6 is the method of any of examples 1-5, wherein the distribution of the one or more uplink gaps is a uniform distribution of the one or more uplink gaps to the second uplink slot of each repetition of the first TDD configuration within the first time window, and wherein the second uplink slot occurs after the first uplink slot in the pattern of uplink and downlink slots.

Examples 7 is the method of any of examples 1-6, further comprising: obtaining, from the base station, a slot offset value configured to offset the uniform distribution of the one or more uplink gaps; and offsetting, based on the slot offset value, the uniform distribution of the one or more uplink gaps from the second uplink slot to the first uplink slot of each repetition of the first TDD configuration within the first time window.

Example 8 is the method of any of examples 1-7, wherein the method further comprises obtaining, from the base station, a second TDD configuration, wherein the first TDD configuration is indicative of a first pattern of uplink and downlink slots, and the second TDD configuration is indicative of a second pattern of uplink and downlink slots, wherein the first pattern and the second pattern are repeated within the first time window.

Example 9 is the method of any of examples 1-8, wherein the second pattern comprises a number of uplink slots that is greater than a number of uplink slots of the first pattern, wherein the method further comprises distributing the one or more uplink gaps to an uplink slot of the second pattern based on the number of uplink slots associated with the second pattern, and wherein the uplink slot of the second pattern is a last uplink slot of the second pattern.

Example 10 is the method of any of examples 1-9, wherein the first TDD configuration corresponds to a first bandwidth part (BWP) defined by a first subcarrier spacing (SCS), wherein the method further comprises obtaining, from the base station, a second TDD configuration corresponding to a second BWP defined by a second SCS, and wherein each of the first TDD configuration and the second TDD configuration are associated with the first ULGP.

Example 11 is the method of any of examples 1-10, wherein the first ULGP is associated with a second time window indicative of a maximum aggregate duration of the one or more uplink gaps within the first time window, and wherein the method further comprises: determining that the second time window is shorter than a slot length of the second SCS; and scaling up the second time window for the second SCS such that a ratio between the scaled up second time window and the first time window is within a threshold range, wherein the distribution of the one or more uplink gaps within the first time window is determined based on the first TDD configuration, the first ULGP configuration, and the second TDD configuration.

Example 12 is the method of any of examples 1-11, wherein the distribution of the one or more uplink gaps within the first time window is determined based on a lower SCS of the first SCS and the second SCS regardless of which of the first BWP or the second BWP is active, and wherein a location of the one or more uplink gaps within the first time window based on the first SCS is the same location of the one or more uplink gaps within the first time window based on the second SCS.

Example 13 is the method of any of examples 1-12, wherein the method further comprises outputting for transmission, to the base station, a request for the ULGP configuration.

Example 14 is the method of any of examples 1-13, wherein the request for the ULGP configuration is output for transmission in response to a signal, transmitted by the base station, querying the UE for an uplink gap determination, and wherein the method further comprises determining whether to request the ULGP configuration based on at least one of the first TDD configuration, a subcarrier spacing (SCS) associated with the first TDD configuration, or an expected improvement to the wireless communication between the UE and the base station.

Example 15 is a method for wireless communications at a base station, comprising: outputting for transmission, to a user equipment (UE), a first time division duplex (TDD) configuration for wireless communications between the UE and the base station; determining to provide the UE with an uplink gap pattern (ULGP) configuration indicating a first ULGP associated with a first time window and the first TDD configuration; and outputting the ULGP configuration for transmission to the UE based on the determination to provide the UE with the ULGP configuration.

Example 16 is the method of example 15, wherein the determination to provide the UE with the ULGP is based on at least one of the first TDD configuration, a subcarrier spacing (SCS) associated with the first TDD configuration, or an expected improvement to the wireless communication between the UE and the base station.

Example 17 is the method of any of examples 15 and 16, wherein the method further comprises outputting for transmission, to the UE, a slot offset value configured to indicate a uniform distribution of one or more uplink gaps within the first time window.

Example 18 is the method of any of examples 15-17, further comprising obtaining a request from the UE for the ULGP configuration, wherein the first TDD configuration is output for transmission to the UE in response to the request.

Example 19 is a UE, comprising: a transceiver; a memory comprising instructions; and one or more processors configured to execute the instructions to cause the UE to perform a method in accordance with any one of examples 1-14, wherein the transceiver is configured to: receive, from a base station, a first time division duplex (TDD) configuration for wireless communications between the UE and the base station; receive, from the base station, an uplink gap pattern (ULGP) configuration indicating a first ULGP associated with a first time window and the first TDD configuration; and transmit, to the base station, uplink signaling according to the distribution of the one or more uplink gaps.

Example 20 is a base station, comprising: a transceiver; a memory comprising instructions; and one or more processors configured to execute the instructions and cause the base station to perform a method in accordance with any one of examples 15-18, wherein the transceiver is configured to: transmit, to a user equipment (UE), a first time division duplex (TDD) configuration for wireless communications between the UE and the base station; and transmit the ULGP configuration to the UE based on the determination to provide the UE with the ULGP configuration.

Example 21 is an apparatus for wireless communications, comprising means for performing a method in accordance with any one of examples 1-14.

Example 22 is an apparatus for wireless communications, comprising means for performing a method in accordance with any one of examples 15-18.

Example 23 is a non-transitory computer-readable medium comprising instructions that, when executed by an apparatus, cause the apparatus to perform a method in accordance with any one of examples 1-14.

Example 24 is a non-transitory computer-readable medium comprising instructions that, when executed by an apparatus, cause the apparatus to perform a method in accordance with any one of examples 15-18.

What is claimed is:

1. An apparatus for wireless communications, comprising:
a memory comprising instructions; and
one or more processors configured to execute the instructions and cause the apparatus to:
obtain, from a base station, a first time division duplex (TDD) configuration for wireless communications between the apparatus and the base station;
obtain, from the base station, an uplink gap pattern (ULGP) configuration indicating a first ULGP associated with a first time window and the first TDD configuration; and
output for transmission, to the base station, uplink signaling according to a distribution of the one or more uplink gaps within the first time window, wherein the distribution of the one or more uplink gaps is based on the first TDD configuration and the first ULGP.

2. The apparatus of claim 1, wherein the first time window is indicative of a repetition periodicity of the one or more uplink gaps for the first ULGP.

3. The apparatus of claim 1, wherein the first ULGP is associated with a second time window indicative of a maximum aggregate duration of the one or more uplink gaps within the first time window.

4. The apparatus of claim 1, wherein the distribution of the one or more uplink gaps within the first time window is a uniform distribution of the one or more uplink gaps to uplink symbols of the first TDD configuration within the first time window.

5. The apparatus of claim 1, wherein the first TDD configuration is indicative of a pattern of uplink and downlink slots repeated within the first time window, and wherein the pattern of uplink and downlink slots comprises at least a first uplink slot and a second uplink slot contiguous to the first uplink slot.

6. The apparatus of claim 5, wherein the distribution of the one or more uplink gaps is a uniform distribution of the one or more uplink gaps to the second uplink slot of each repetition of the first TDD configuration within the first time window, and wherein the second uplink slot occurs after the first uplink slot in the pattern of uplink and downlink slots.

7. The apparatus of claim 6, wherein the one or more processors are further configured to cause the apparatus to:
obtain, from the base station, a slot offset value configured to offset the uniform distribution of the one or more uplink gaps; and
offset, based on the slot offset value, the uniform distribution of the one or more uplink gaps from the second uplink slot to the first uplink slot of each repetition of the first TDD configuration within the first time window.

8. The apparatus of claim 1, wherein the one or more processors are further configured to cause the apparatus to obtain, from the base station, a second TDD configuration, wherein the first TDD configuration is indicative of a first pattern of uplink and downlink slots, and the second TDD configuration is indicative of a second pattern of uplink and downlink slots, wherein the first pattern and the second pattern are repeated within the first time window.

9. The apparatus of claim 8, wherein the second pattern comprises a number of uplink slots that is greater than a number of uplink slots of the first pattern, wherein the one or more processors are further configured to cause the apparatus to distribute the one or more uplink gaps to an uplink slot of the second pattern based on the number of uplink slots associated with the second pattern, and wherein the uplink slot of the second pattern is a last uplink slot of the second pattern.

10. The apparatus of claim 1, wherein the first TDD configuration corresponds to a first bandwidth part (BWP) defined by a first subcarrier spacing (SCS), wherein the one or more processors are further configured to cause the apparatus to obtain, from the base station, a second TDD configuration corresponding to a second BWP defined by a second SCS, and wherein each of the first TDD configuration and the second TDD configuration are associated with the first ULGP.

11. The apparatus of claim 10, wherein the first ULGP is associated with a second time window indicative of a maximum aggregate duration of the one or more uplink gaps within the first time window, and wherein the one or more processors are further configured to cause the apparatus to:
if the second time window is shorter than a slot length of the second SCS, scale up the second time window for the second SCS such that a ratio between the scaled up second time window and the first time window is within a threshold range, wherein the distribution of the one or more uplink gaps within the first time window is determined based on the first TDD configuration, the first ULGP, and the second TDD configuration.

12. The apparatus of claim 10, wherein the distribution of the one or more uplink gaps within the first time window is determined based on a lower SCS of the first SCS and the second SCS regardless of which of the first BWP or the second BWP is active, and wherein a location of the one or more uplink gaps within the first time window based on the first SCS is the same location of the one or more uplink gaps within the first time window based on the second SCS.

13. The apparatus of claim 1, wherein the one or more processors are further configured to cause the apparatus to output, for transmission to the base station, a request for the ULGP configuration.

14. The apparatus of claim 13, wherein the request for the ULGP configuration is outputted for transmission in response to a signal, transmitted by the base station, querying the apparatus for an uplink gap determination, and wherein the one or more processors are further configured to cause the apparatus to:
request the ULGP configuration based on at least one of the first TDD configuration, a subcarrier spacing (SCS) associated with the first TDD configuration, or an expected improvement to the wireless communications between the apparatus and the base station.

15. A user equipment (UE) for wireless communications, comprising:
a transceiver;
a memory comprising instructions; and
one or more processors configured to execute the instructions and cause the UE to:
receive, from a base station via the transceiver, a first time division duplex (TDD) configuration for wireless communications between the UE and the base station;
receive, from the base station via the transceiver, an uplink gap pattern (ULGP) configuration indicating a first ULGP associated with a first time window and the first TDD configuration;
transmit, to the base station via the transceiver, uplink signaling according to a distribution of the one or more uplink gaps within the first time window, wherein the distribution of the one or more uplink gaps is based on the first TDD configuration and the first ULGP.

16. An apparatus for wireless communications, comprising:
a memory comprising instructions; and
one or more processors configured to execute the instructions and cause the apparatus to:
output, for transmission to a user equipment (UE), a first time division duplex (TDD) configuration for wireless communications between the UE and the apparatus;
output, for transmission to the UE, an uplink gap pattern (ULGP) configuration indicating a first ULGP associated with a first time window and the first TDD configuration.

17. The apparatus of claim 16, wherein the ULGP is output for transmission to the UE based on at least one of the first TDD configuration, a subcarrier spacing (SCS) associated with the first TDD configuration, or an expected improvement to the wireless communication between the UE and the apparatus.

18. The apparatus of claim 16, wherein the one or more processors are further configured to cause the apparatus to output, for transmission to the UE, a slot offset value configured to indicate a uniform distribution of one or more uplink gaps within the first time window.

19. The apparatus of claim 16, further comprising:
obtaining a request from the UE for the ULGP configuration, wherein the first TDD configuration is outputted for transmission to the UE in response to the request.

20. The apparatus of claim 16, further comprising a transceiver configured to:
transmit the first TDD configuration; and
transmit the ULGP configuration, wherein the apparatus is configured as a base station.
